(19) United States
(12) Patent Application Publication
(10) Pub. No.: US 2010/0221973 A1
(43) Pub. Date: Sep. 2, 2010

(54) COMPOSITE MATERIALS, METHOD FOR THEIR MANUFACTURE AND THEIR USE

(75) Inventors: Michael Ketzer, Collenberg (DE); Klaus Friedrich Gleich, Highlands Ranch, CO (US); Bernd Christensen, Wertheim (DE); Alan Jaffee, Bowling Green, OH (US); Phil Miele, Highlands Ranch, CO (US); Glenda Bennett, Toledo, OH (US); Bernhard Eckert, Freudenberg-Boxtal (DE); Annette Albrecht, Wertheim (DE)

Correspondence Address: JOHNS MANVILLE, 10100 WEST UTE AVENUE, PO BOX 625005, LITTLETON, CO, 80162-5005, US

(73) Assignee: JOHNS MANVILLE, Denver, CO (US)

(21) Appl. No.: 12/527,708

(22) PCT Filed: Feb. 20, 2008
(86) PCT No.: PCT/EP2008/001302

§ 371 Date: Aug. 19, 2009

(30) Foreign Application Priority Data
Feb. 21, 2007 (DE) 10 2007 008 423.6
Feb. 21, 2007 (DE) 10 2007 008 424.4
Mar. 16, 2007 (DE) 10 2007 012 651.6
Jun. 18, 2007 (DE) 10 2007 028 531.2

(51) Int. Cl. B32B 29/02; B32B 5/02; B29C 65/02

(52) U.S. Cl. 442/412; 442/327; 156/279; 156/278

(57) ABSTRACT

The invention relates to the manufacture of new composite materials suitable in particular as materials in interior construction, for linings, constructions and for the manufacture of furniture and similar products.

### BACKGROUND

The invention relates to new composite materials suitable in particular as materials in interior construction, for linings, constructions and for the manufacture of furniture and similar products.

Composite materials are increasingly replacing traditional building materials as construction materials and must be adapted for manifold applications. Thus, on the one hand a sufficient mechanical stability is required and on the other hand a good workability and low weight are necessary. There has therefore been no lack of attempts to improve existing composite materials.

Thus, the combining of wood materials, which are manufactured from comminuted wood and the use of binders, with further materials is already known. To this end, the two materials are usually laminated and form a composite material. The selection and combination of the materials can improve the mechanical properties and at the same time a reduction, e.g. of the weight, can be achieved.

Composite materials based on wooden materials and non-woven fabrics strengthened by a “B” stage binder are known from WO2006/031522. The base non-woven fabrics are known, e.g., from U.S. Pat. Nos. 5,837,620, 303,207 and 6,331,339. The cited publications do disclose in a general manner that further additives can be added to the binder and/or to the non-woven fabric but more detailed data is not given.

There was therefore the task of optimizing the already known products with regard to their application technology properties and to the manufacturing processes.

### SUMMARY

Subject matter of the present invention is a method for the manufacture of a composite material comprising the measures:
a) Supplying of a carrier,
b) Application of a textile surface structure onto at least one surface of the carrier, the textile surface structure having at least one binder in the B-stage state and has at least one functional material,
c) Lamination of the construction obtained according to step b) under the action of pressure and heat so that the binder present in the B stage receives its final hardening,
d) Optional application of at least one further protective layer and drying.

Also provided is a method for manufacturing a semifinished product comprising supplying a carrier; applying a textile surface structure onto at least one surface of the carrier to provide a pre-laminated construction, wherein the textile surface structure has at least one binder present in a B-stage state and wherein the textile surface structure was subjected to a strengthening before it was provided with the at least one binder present in the B-stage state; and laminating the pre-laminated construction under pressure and heat so that the at least one binder present in the B-stage state receives its final hardening.

Further provided is a composite material comprising a carrier; at least one textile surface structure applied onto at least one side of the carrier; and at least one functional material applied on top of the textile surface structure or introduced into the textile surface structure. The textile surface structure comprises at least one finally hardened B-stage binder

Additionally provided is a semifinished product comprising a carrier and at least one textile surface structure applied onto at least one surface of the carrier. The textile surface structure has at least one binder present in a B-stage state and an additional strengthening.

Moreover provided is a decorative semifinished product comprising at least one textile surface structure containing at least one B-stage binders and at least one decorative layer.

### DETAILED DESCRIPTION

The carrier used in accordance with step a) is preferably wooden materials, papers, cork, cardboards, mineral plates and/or so-called honeycombs. Honeycombs are structural components with three-dimensional reinforcement structures that make possible an extraordinary stability and strength with low weight at the same time on account of their construction (bee honeycomb structure). Such honeycombs have been used for some time in many areas of application, among others also as inner reinforcement of plate-shaped elements in the construction area or in furniture.

The wooden materials are plate-shaped or strand-shaped wooden materials manufactured by mixing the different wooden particle forms with natural and/or synthetic binding agents during a hot pressing. The wooden materials used in accordance with the invention preferably comprise plywood or laminated wood, wood-chip material, especially chipboards and OSB (Oriented Strand Boards), wood fiber material, especially porous wood fiber boards, open-diffusion wood fiber boards, hard (high-density) wood fiber boards (HDF) and medium-density wood fiber boards (MDF), and Arboform. Arboform is a thermoplastically workable material of lignin and other wood components.

The papers are preferably papers on the basis of natural, synthetic, mineral or ceramic fibers or also of mixtures of these fiber types.

The cardboards are preferably cardboards on the basis of natural and/or synthetic fibers, which also comprise mineral and/or ceramic fibers as well as mixtures of these fiber types.

The mineral plates are preferably commercial mineral cardboard plates with cardboard coating on both sides, gypsum fiber plates, ceramic fiber plates, cement plates or lime plates. The plates can optionally be reinforced with natural and/or synthetic fibers, wherein these can also comprise mineral and/or ceramic fibers. The reinforcement fibers can be present in the form of filaments, monofilaments or as staple fibers.

In addition to the described materials the carrier can also consist of cork or other vegetable materials.

The weight per unit area of the carriers contained in the composite material is a function of the final application and is not subject to any particular limitation.

The textile surface structures used in accordance with step b) are all structures manufactured from fibers and from which a textile surface was produced by means of a surface-forming technology.

The textile surface structures to be provided with the B-stage binder can also basically be used without binders, in particular chemical binders. However, in order to ensure the required strengths in the further working of the surface structures binders can also be introduced and/or known needling methods can be used. In addition to the possibility of a mechanical strengthening, e.g., by calendering or needling, in particular the hydrodynamic needling is also mentioned here. Chemical and/or thermoplastic binders are suitable as binders.

However, the textile surface structures to be provided with the B-stage binder are preferably pre-strengthened a with a chemical binder. The binders used can be the same or different but must be selected from the group of the binder systems compatible with the B-stage binder. The additional binder component is maximally 25% by weight, preferably 10% by weight or less; the minimum content is 0.5% by weight, preferably a minimum of 1% by weight.

The fiber-forming materials are preferably natural fibers and/or fibers of synthesized or natural polymers, ceramic fibers, mineral fibers or glass fibers that can also be used in the form of mixtures. Textile surfaces are considered to be tissues, layings, knitted fabrics, knitwear and non-woven fabrics, preferably non-woven fabrics.

The textile surfaces of mineral and ceramic fibers are aluminosilicate fibers, ceramic fibers, dolomite fibers, wollastonite fibers or fibers of vulcanites, preferably basalt fibers, diabase fibers and/or melaphyr fibers, especially basalt fibers. Daibases and melaphyrs are designated combined as paleobasalts and diabase is also often designated as greenstone.

The mineral fiber non-woven fabric can be formed from filaments, that is, infinitely long fibers or of staple fibers. The average length of the staple fibers in the non-woven fabric of mineral fibers used in accordance with the invention is between 5 and 120 mm, preferably 10 to 90 mm. In a further embodiment of the invention the mineral fiber non-woven fabric contains a mixture of endless fibers and staple fibers. The average fiber diameter of the mineral fibers is between 5 and 30 μm, preferably between 8 and 24 μm, especially preferably between 8 and 15 μm.

The weight per unit area of the textile surface structure of mineral fibers is between 15 and 500 g/m², preferably 40 and 250 g/m², wherein these data refer to a surface structure without binders.

In the case of the textile fibers of glass fibers non-woven fabrics are particularly preferred. They are constructed from filaments, that is, infinitely long fibers or of staple fibers. The average length of the staple fibers is between 5 and 120 mm, preferably 10 to 90 mm. In a further embodiment of the invention the glass fiber non-woven fabric contains a mixture of endless fibers and staple fibers.

The average diameter of the glass fibers is between 5 and 30 μm, preferably between 8 and 24 μm, especially preferably between 10 and 21 μm.

In addition to the previously cited diameters so-called glass microfibers can also be used. The preferred average diameter of the glass microfibers is between 0.1 and 5 μm. The microfibers forming the textile surface can also be present in mixtures with other fibers, preferably glass fibers. Moreover, a layer-shaped construction of microfibers and glass fibers is also possible.

The textile surface structure can also additionally have a reinforcement of fibers, threads or filaments. Reinforcement threads are preferably multi-filaments or rovings based on glass, polyester, carbon or metal. The reinforcement threads can be used as such or also in the form of a textile surface structure, e.g., as fabric, laying, knitted fabric, knitwear or non-woven fabric. The reinforcements preferably consist of a parallel thread sheet or of a laying.

The weight per unit area of the textile surface structure of glass fibers is between 15 and 500 g/m², preferably 40 and 250 g/m², wherein the data refers to a surface structure without binders.

Suitable glass fibers comprise those manufactured from A-glass, E-glass, S-glass, T-glass or R-glass.

The textile surface can be manufactured according to any known method. For glass non-woven fabrics this is preferably the dry- or wet laying method.

Among the textile surfaces of fibers of synthetic polymers, non-woven fabrics, especially so-called spun bonds, that is, spunbonded non-woven fabrics produced by a tangled deposit of melt-spun filaments, are preferred. They consist of endless synthetic fibers of melt-spinnable polymer materials. Suitable polymer materials are, e.g., polyamides such as, e.g., polyhexamethylene diadipamide, polycaprolactam, aromatic or partially aromatic polyamides (“aramids”), aliphatic polyamides such as, e.g., nylon, partially aromatic or fully aromatic polyesters, polyphenylene sulfide (PPS), polymers with ether—and keto groups such as, e.g., polyetherketones (PEK) and polyetheretherketone (PEEK), polyolefins such as, e.g., polyethylene or polypropylene, cellulose or polybenzimidazoles. In addition to the previously cited synthetic polymers, those polymers are also suited that are spun from solution.

The spunbonded non-woven fabrics preferably consist of melt-spinnable polyesters. In principle, all known types of polyester material suitable for the manufacture of fibers are considered as polyester material. Polyesters containing at least 95 mole % polyethyleneterephthalate (PET), especially those of unmodified PET, are especially preferable.

If the composite materials in accordance with the invention should additionally have a flame-retardant action, it is advantageous if they were spun from polyesters modified in a flame-retardant manner. Such polyesters modified in a flame-retardant manner are known.

The individual titers of the polyester filaments in the spunbonded non-woven fabric are between 1 and 16 dtex, preferably 2 to 10 dtex.

In a further embodiment of the invention the spunbonded non-woven fabric can also be a bonded fiber fabric hardened by melt binder and which contains carrier fibers and melded fibers. The carrier fibers and melded fibers can be derived from any thermoplastic, fiber-forming polymers. Such spunbonded non-woven fabrics hardened by melt binder are described, e.g., in EP-A-0,446,822 and EP-A-0,590,629.

In addition to endless filaments (spunbond method) the textile surface can also be constructed of staple fibers or mixtures of staple fibers and endless filaments. The individual titers of the staple fibers in the non-woven fabric are between 1 and 16 dtex, preferably 2 to 10 dtex. The staple length is 1 to 100 mm, preferably 2 to 500 mm, especially preferably 2 to 30 mm. The textile surface structure can also be constructed of fibers of different materials in order to be able to achieve special properties.

The textile surface structure can also additionally have a reinforcement of fibers, threads or filaments. Multi-filaments or rovings based on glass, polyester, carbon or metal are preferred as reinforcement threads. The reinforcement threads can be used as such or also in the form of a textile surface structure, e.g., as fabric, laying, knitted fabric, knitwear or non-woven fabric. The reinforcements preferably consist of a parallel thread sheet or a laying.

The filaments and/or staple fibers constructing the bonded fiber fabric can have a practically round cross-section or also other forms such as dumbbell-shaped, kidney-shaped, triangular or tri- or multi-lobed cross-sections. Hollow fibers and bi- or multi-component fibers can also be used. Furthermore, the melded fibers can also be used in the form of bi-component or multi-component fibers.

The fibers forming the textile surface structure can be modified by customary additives, e.g., by antistatic agents such as carbon black.

The weight per unit area of the textile surface structure of fibers of synthetic polymers is between 10 and 500 g/m², preferably 20 and 250 g/m².

The natural fibers are vegetable fibers, fibers derived from grasses, straw, wood, bamboo, reed and bast, or fibers of animal origin. Plant fibers is a collective concept and stands for seed fibers such as cotton, kapok or poplar fluff, bast fibers such as bamboo fiber, hemp, jute, linen or ramie, hart fibers such as sisal or manila, or fruit fibers such as coconut. Fibers of animal origin are wools, animal hairs, feathers and silks.

The weight per unit area of the textile surface structure of natural fibers is between 20 and 500 g/m², preferably 40 and 250 g/m².

The textile surfaces of fibers of natural polymers are cellulose fiber such as viscose or vegetable or animal protein fibers.

Among the textile surfaces of cellulose fibers non-woven fabrics are especially preferred. They are constructed from filaments, that is, infinitely long fibers and/or from staple fibers. The average length of the staple fibers is between 1 and 25 mm, preferably 2 to 5 mm.

The average diameter of the cellulose fibers is between 5 and 50 μm, preferably between 15 and 30 μm.

The textile surface structure used according to step b), which is applied at least on one side of the carrier, comprises at least one binder in the B-stage state.

B-stage binders denotes binders that are only partially strengthened or hardened and can still experience a final hardening, e.g., by thermal post-treatment. Such B-stage binders are exhaustively described in U.S. Pat. Nos. 5,837,620, 6,303,207 and 6,331,339. The B-stage binders disclosed there are also subject matter of the present description. B-stage binders are preferably binders based on furfuryl alcohol formaldehyde, phenol formaldehyde, melamine formaldehyde, urea formaldehyde and their mixtures. Preferably, aqueous systems are concerned. Further preferred binder systems are formaldehyde-free binders. B-stage binders are distinguished in that they can be subjected to a multistage hardening, that is, they still have a sufficient binding action after the first hardening or after the first hardenings so that they can be used for the further processing.

Such binders are usually hardened after the addition of a catalyst at temperatures of ca. 350° F. in one step.

In order to form the B-stage, such binders are optionally hardened after the addition of a catalyst. The amount of hardening catalyst is up to 10% by weight, preferably 0.25 to 7% by weight (relative to the total binder content). For example, ammonium nitrate as well as organic aromatic acids, e.g., maleic acid and p-toluene sulfonic acid are suitable as hardening catalyst since it allows the B-stage state to be more rapidly reached. In addition to ammonium nitrate, maleic acid and p-toluene sulfonic acid, all materials are suitable as hardening catalyst that have a comparable acidic function. In order to reach the B-stage the textile surface structure impregnated with the binder is dried under the influence of temperature without producing a complete hardening. The necessary process parameters are dependent on the binder system selected.

The lower as well as the upper temperature limit can be influenced by the selection of the duration and/or by adding or avoiding rather large or rather strong acidic hardening catalysts and/or by optionally using stabilizers.

The application of the B-stage binder onto the textile surface structure designated in measure b) can take place with the aid of all known methods. In addition to spraying on, impregnating and pressing in, the binder can also be applied by coating or by rotary nozzle heads.

A further preferred method is the application of the B-stage binder by the application of foam. In the application of foam a binder foam is produced with the aid of a foaming agent in a foam mixer that is applied by suitable coating aggregates onto the non-woven fabric. The application can also take place here by rotary nozzle heads.

In the foam coating of a B-stage-capable binder there are basically no limitations regarding the foaming agent. Preferred foaming agents are ammonium stearates or succinic acid esters added with 1%-5% by weight in dry mass to the binder. Furthermore, the already described catalysts are mixed in if required. The solids content of the foam is at least 40%, preferably at least 50%.

The process of foam application makes possible an extremely flexible process control and permits the realization of a plurality of different product properties. In addition to the purposeful adjusting of the penetration depth of the foam into the textile surface the binder charge and porosity can vary within broad limits. In addition, the application of foam offers great advantages in the process control, especially regarding the constancy of the solids content during the impregnating or coating of the textile surface and the required compatibility requirements of the surface manufacturing process on the binder.

The functional material used according to step b) can be applied at the same time with the B-stage binder, e.g., as mixture or as individual components, or before or after the application of the binder. In as far as the B-stage binder is applied by foam application it is advantageous to apply the functional material with the foam or distributed in the foam or to apply the functional material onto the still fresh foam.

The functional material used according to step b) is preferably flameproofing agents, materials for discharging electrostatic charges, materials for screening off electromagnetic rays, organic or inorganic pigments, especially colored pigments, materials that increase the resistance to wear and/or slippage, or decorative layers. The functional materials are preferably arranged on the side of the textile surface structure facing away from the carrier and can at least partially pass through the non-woven fabric.

In a variant of the method an additional binder is added to fix the functional materials on the textile surface structure. The same binder (B-stage binder) as is present in the textile surface structure is preferably selected here. The content of functional materials is determined by the subsequent use.

The flameproofing agents are inorganic flameproofing agents, organophosphorus flameproofing agents, nitrogen-based flameproofing agents or intumescence flameproofing agents. Halogenated (brominated and chlorinated) flameproofing agents can also be used but are less preferred on account of their risk evaluation. Examples for such halogenated flameproofing agents are polybrominated diphenylether, e.g., decaBDE, tetrabromobisphenol A and HBCD (hexabromocyclododecane).

The nitrogen-based flameproofing agents are melamines and urea.

The organophosphorus flameproofing agents are typically aromatic and alkyl esters of phosphoric acid. TCEP (trischloroethylphosphate), TCCP (trischloropropylphosphate), TDCCP (trisdichloroisopropylphosphate), triphenylphosphate, trioctylphosphate (tris-(2-ethylhexyl)phosphate) are preferably used.

The inorganic flameproofing agents are typically hydroxides such as aluminum hydroxide and magnesium hydroxide, borates such as zinc borate, ammonium compounds such as ammonium sulfate, red phosphorus, antimony oxides such as antimony trioxide and antimony pentoxide and/or laminated silicates such as vermiculite.

Antistatic—and electromagnetic screening effects can be achieved by the use of agents for raising the electrical conductivity.

The antistatic agents are usually particles that are electrically conductive. Suitable materials are electrically conductive carbons such as carbon black, graphite and carbon nanotubes (C-nanotubes), conductive plastics or fibers of metal or metallic components.

The materials for screening electromagnetic rays are usually electrically conductive materials. They can be built up in the form of foils, particles, fibers or wires and/or textiles surface structures of the previously cited materials.

The inorganic or organic pigments are particulate materials. In addition to fillers such as CaCO3, talcum, gypsum or silica, the pigments, to the extent that they should increase the value of the composite material, are in particular pigments that can be used in colors.

In addition to increasing the value, materials are also used that increase the application suitability. In particular an anti-slippage coating is to be understood here as well as a coating that ensures an increased wear protection. Sic and/or SiO2 particles are preferably used for the anti-slippage coating with a grain size of preferably 2-5 mm. The amount is 1-40%, preferably 10-30%. In order to increase the effectiveness of the coating and to reduce the amount of the coating used the surface can additionally be structured.

Comparable materials are used for the surface enhancement in order to improve the abrasion and hardness. However, grain sizes of below 1 mm are used, which can produce a very hard surface.

In as far as the functional layer should be an anti-slippage coating, it is advantageous if it or the basic particles are present entirely or at least partially worked into the textile surface structure and/or the B-stage binder. In particular in the case of an anti-slippage coating and service enhancement in order to improve the abrasion and hardness it is advantageous if the particles are applied on to the textile surface structure in such a manner that the particles project at least partially from the surface of the textile surface structure. The resulting rugosity, in particular for an anti-slippage coating, must meet the appropriate national norms and regulations.

The decorative layers are decorative elements. This is understood to include decorative layers and patterns that increase the value of the composite material. Examples of such patterns are veneers, cork, decorative papers, foils with wood grainings, overlay papers, HPL, CPL (laminates built up in multilayers) or chips of paper or plastic with different colors that are also designated as decorative semifinished products. For their part, these decorative semifinished products can contain B-stage-capable binders and/or one or more textile surfaces, preferably non-wovens or non-woven fabric layers.

The application of the functional material used in accordance with step b) takes place as a function of the nature of the particular functional material by known techniques. The application can also take place here by rotary nozzle heads.

The lamination of the construction obtained according to step b) takes place in step c) under the action of pressure and heat in such a manner that the binder present in the B stage receives its final hardening. The lamination can take place by discontinuous or continuous pressing or by rolling. The parameters of pressure, temperature and dwell time are selected in accordance with the B-stage binder used.

The application of at least one further protective layer and its drying in accordance with step d) takes place by known pressure, spraying and lacquering technologies. The application can also take place here by rotary nozzle heads. The drying of the protective layer takes place as a function of the selected system.

The protective layers are usually lacquers such as powdered lacquers, clear lacquers or transparent lacquers, preferably scratch-proof lacquers that protect the functional layer against mechanical influences or against UV ageing.

In a variant of the method in accordance with the invention in measure b) even only the textile surface structure can be applied with at least one binder in the B-stage state and the providing with at least one functional material can take place in a step after measure b).

Such a method—also comprised by the present invention—comprises the measures:
I) supplying of a carrier,
II) application of the textile surface structure on at least one surface of the carrier, the textile surface structure having at least one binder in the B-stage state,
III) optional lamination of the construction obtained according to step II) under the action of pressure and heat so that the binder present in the B stage partially or completely hardens;
IV) application of at least one functional material on the side of the textile surface structure facing away from the carrier,
V) optional lamination of the construction obtained according to step IV) under the action of pressure and heat so that the binder present in the B stage receives its final hardening,
VI) optional application of at least one further protective layer and drying.

The measures I), V) and VI) are identical with the initially cited measures a), c) and d). The application of the textile surface structure containing at least one binder in the B-stage state takes place according to step II) as initially described under measure b), wherein the functional material is not present.

The lamination according to measure III) and VI) takes place under the action of pressure and heat in such a manner that the binder present in the B stage receives its partial or final hardening. The lamination can take place by discontinuous or continuous pressing or by rolling. The parameters of pressure, temperature and dwell time are selected in accordance with the B-stage binder used.

The functional material used according to measure IV) is the functional materials initially described under b), preferably the cited flameproofing materials, materials for discharging electrostatic charges, materials for screening off electromagnetic rays, organic or inorganic pigments, especially colored pigments, materials that increase the resistance to wear and/or slippage, or decorative layers.

In order to fix the functional materials a binder can be additionally added for fixing the functional materials on the textile surface structure. The same binder (B-stage binder) is preferably selected here as is present in the textile surface structure. The content of functional material is determined by the subsequent use.

The application of the functional material in accordance with measure IV) takes place as a function of the nature of the particular functional material by known techniques. The application can also take place here by rotary nozzle heads.

In as far as the B-stage binder or the additional binder is applied by foam application it is advantageous to apply the functional material in accordance with measure IV) with the foam or distributed in the foam or to apply the functional material onto the still fresh foam.

In addition to the above-described method, even the composite materials as such are not known from the state of the art.

Thus, further subject matter of the present invention is a composite material comprising:
a) a carrier,
b) at least one textile surface structure applied onto at least one of the two sides of the carrier which surface structure comprises at least one finally hardened B-stage binder,
c) at least one functional material applied on the top of the textile surface structure provided with the B-stage binder or introduced into the textile surface structure, and
d) optionally further protective layers applied on the functional material.

Variations and modifications of the method in accordance with the invention are possible by using selected textile surface structures.

Further subject matter of the present invention is a method for manufacturing a composite material comprising the measures:
a) supplying of a carrier,
b) application of the textile surface structure on at least one surface of the carrier, the textile surface structure having at least one binder in the B-stage state, and wherein textile surface structure was subjected to a strengthening before it was provided with the b-stage binder,
c) optional application of at least one functional material,
d) lamination of the construction obtained according to step b) or step c) under the action of pressure and heat so that the binder present in the B stage receives its final hardening,
e) optional application of at least one further protective layer and drying.

The strengthening of the textile surface structure designated in measure b) can take place by the mechanical influence of force, preferably by needling and/or calendering and/or pressing, and/or by chemical and/or thermoplastic binders. The binders used can be the same or different but must be selected from the group of the binder systems compatible with the B-stage binder. The additional binder component, that is, the binder component that is allotted to the pre-strengthening, is maximally 25% by weight, preferably 10% by weight or less; the minimum content is 0.5% by weight, preferably 1% by weight.

The textile surface structures to be provided with the B-stage binder are preferably pre-strengthened with a chemical binder.

The application of the functional material optionally used in accordance with step c) takes place as a function of the nature of the particular functional material with known technologies. The application or the introduction can also take place here by rotary nozzle heads.

The measures d) and e)—as described initially under the measures c) and d)—are carried out subsequently.

Conditioned by the selection of pre-strengthened textile surface structures, these composite materials can be more readily processed further and reduce the manufacturing expense.

Further subject matter of the present invention is thus a semifinished product comprising:
a) a carrier, and
b) at least one textile surface structure applied on at least one of the two sides of the carrier which surface structure comprises at least one binder in the B stage and wherein the textile surface structure has an additional strengthening.

The additional strengthening of the textile surface structure designated in measure b) can take place by the mechanical action of force, preferably by needling and/or calendering and/or pressing, and/or by chemical and/or thermoplastic binders. The additionally used binders can be the same or different but must be selected from the group of the binder systems compatible with the B-stage binder. The additional binder component, that is, the binder component allotted to the pre-strengthening, is maximally 25% by weight, preferably 10% by weight or less; the minimum content is 0.5% by weight, preferably a minimum of 1% by weight. The additional strengthening of the textile surface structure preferably takes place before the application of the B-stage binder. The textile surface structures to be provided with the B-stage binder are preferably pre-strengthened with a chemical binder.

Changeovers in the production can be realized more readily and more rapidly and thus more economically by a high degree of pre-strengthening. This flexibility constitutes a significant economic advantage.

In as far as the above semifinished products are already provided with the functional material, they are already the finished composite materials.

Further subject matter of the present invention is thus a semifinished product comprising at least one textile surface structure comprising at least one binder in the B stage and wherein the textile surface structure has an additional strengthening.

Thus, further subject matter of the present invention is a composite material comprising:
a) a carrier,
b) at least one textile surface structure applied onto at least one of the two sides of the carrier which surface structure comprises at least one finally hardened B-stage binder, and wherein the textile surface structure has an additional strengthening,
c) at least one functional material applied on the top of the textile surface structure provided with the B-stage binder or introduced into the textile surface structure, and
d) optionally further protective layers applied on the functional material.

The additional strengthening of the textile surface structure designated in measure b) has already been described above. The same applies to the carrier, the B-stage binder, the functional material and the protective layers.

Furthermore, the invention also comprises decorative semifinished products, in particular CPL and HPL, comprising at least one textile surface structure containing B-stage binders, preferably a non-woven fabric comprising at least one functional layer.

CPL and HPL typically consist of several, usually 2-50 layers of kraft paper that are impregnated with a melamine, MUF or phenol B-stage binder. In as far as these CPL's and/or HPL's comprise at least one non-woven fabric containing a B-stage binder, a significant reduction of the number of layers of kraft paper up to a complete replacement of the paper layers can take place.

The use of a non-woven fabric comprising a B-stage binder reduces the number of layers of kraft paper by at least one layer, but preferably by at least 50% of the layers of kraft paper with otherwise identical properties of the laminate. The reduction of the amount of binder-impregnated kraft paper allows an improvement of the fire classification, which can extend to the classification of “noncombustible”.

Further subject matter of the invention is therefore decorative semifinished products, in particular CPL and/or HPL comprising at least one textile surface structure containing B-stage binders, preferably a non-woven fabric, wherein the textile surface structure can also be pre-strengthened. This can result in a further reduction of kraft paper layers.

The CPL's and/or HPL's in accordance with the invention preferably have between 1 and 25 layers of a non-woven fabric with a B-stage binder. In addition, the CPL's and/or HPL's in accordance with the invention can have even more layers of kraft paper impregnated with a melamine, MUF or phenol B-stage binder.

The manufacture of the decorative semifinished product takes place by lamination under the action of pressure and heat in such a manner that the binder present in the B stage is partially or finally hardened. The lamination can takes place by discontinuous or continuous pressing or by rolling. The parameters of pressure, temperature and dwell time are selected in accordance with the B-stage binder used.

The previously cited materials are suitable as carrier, textile surface structure, B-stage binder, functional material and protective layer. The preferred embodiments disclosed in the scope of the method in accordance with the invention also apply to the composite material of the invention.

The previously cited functional material can be present in the form of an independent layer applied in the B stage on the side of the textile surface structure facing away from the carrier or can also entirely or partially penetrate the textile surface structure. These embodiments are suitable for functional materials such as flameproofing agents, materials for discharging electrostatic charges, materials for screening off electromagnetic charges, materials for screening off electromagnetic rays, organic or inorganic pigments, especially colored pigments or decorative layers.

In a preferred embodiment the functional material forms a discrete layer in the composite material of the invention. This embodiment is especially suitable for functional materials that increase the resistance to wear and/or slippage and/or increase the value by the optical effect of the surface. It is especially advantageous if the functional material is to make anti-slippage material or an increased resistance to wear if the basic particles project at least partially from the textile surface structure provided with the B-stage binder.

The functional material is present in the carrier and/or on the side of the textile surface structure facing away from the carrier.

The composite material in accordance with the invention makes possible a direct workability for the subsequent applications since the composite material already contains the necessary provisioning with functional material.

In a variant the application of an equipped textile surface structure in accordance with step b) can also take place during the manufacturing of the carrier. In other words, instead of the finished carrier in step a), the carrier is formed in step a). The pressing of the formed carrier takes place together with the equipped textile surface structure, the textile surface structure being appropriately introduced into the pressing and/or drying apparatus for the carrier. The manufacture of the carrier-non-woven fabric composite can take place continuously or discontinuously.

While various embodiments have been described, it is to be understood that variations and modifications may be resorted to as will be apparent to those skilled in the art. Such variations and modifications are to be considered within the purview and scope of the claims appended hereto.

1. A method for manufacturing a composite material comprising:
a) supplying a carrier;
b) applying a textile surface structure onto at least one surface of the carrier to provide a pre-laminated construction, wherein the textile surface structure has at least one binder present in a B-stage state and at least one functional material; and
c) laminating the pre-laminated construction under pressure and heat so that the at least one binder present in the B-stage state receives its final hardening; and
d) applying at least one protective layer and drying.

2. The method according to claim 1, wherein supplying the carrier comprises forming the carrier.

3. The method according to claim 1, wherein the carrier is selected from the group consisting of wooden materials, papers, cork, cardboards, mineral plates, honeycombs, and combinations thereof.

4. The method according to claim 3, wherein the wooden materials are selected from the group consisting of plate-shaped and strand-shaped wooden materials.

5. The method according to claim 4, wherein the wooden materials are selected from the group consisting of plywood, laminated wood, wood-chip material, chipboards, Oriented Strand Boards (OSB), wood fiber material, porous wood fiber boards, open-diffusion wood fiber boards, hard (high-density) wood fiber boards (HDF), medium-density wood fiber boards (MDF), and Arboform.

6. The method according to claim 3, wherein the mineral plates are selected from the group consisting of plates with cardboard coating on both sides, gypsum fiber plates, ceramic fiber plates, cement plates, and lime plates.

7. The method according to claim 1, wherein the textile surface structure is selected from the group consisting of a fabric, laying, knitted fabric, knitwear, and non-woven fabric.

8. The method according to claim 1, wherein the textile surface structure is formed from natural fibers, fibers of synthesized or natural polymers, ceramic fibers, mineral fibers, glass fibers, and mixtures thereof.

9. The method according to claim 1, wherein the textile surface structure comprises a glass fiber non-woven fabric of filaments, staple fibers, or combinations thereof.

10. The method according to claim 8, wherein the glass fiber non-woven fabric comprises glass microfibers whose average diameter is between 0.1 and 5 μm.

11. The method according to claim 8, wherein the glass fiber non-woven fabric has a weight per unit area without binders of 15 to 500 g/m².

12. The method according to claim 1, wherein the textile surface structure comprises fibers of synthetic polymers.

13. The method according to claim 1, wherein at least one binder present in the B-stage state can also experience a final hardening.

14. The method according to claim 13, wherein the at least one binder present in the B-stage state is applied as foam.

15. The method according to claim 13, wherein the at least one binder present in the B-stage state is selected from the group consisting of a binder based on furfuryl alcohol formaldehyde, phenol formaldehyde, melamine formaldehyde and mixtures thereof.

16. The method according to claim 1, wherein the functional material is selected from the group consisting of flameproofing agents, materials for controlling or elevating electrostatic charges, organic or inorganic pigments, colored pigments, materials that increase the resistance to wear or slippage, and decorative layers.

17. The method according to claim 16, wherein the functional material is selected from the group consisting of an anti-slippage coating, a coating with elevated wear protection, or an anti-slippage coating with elevated wear protection.

18. The method according to claim 16, wherein the anti-slippage coating comprises particles selected from SiC particles, SiO₂ particles, and combinations thereof

19. The method according to claim 16, wherein the decorative layers are selected from the group consisting of veneers, foils with wood grainings, overlay papers, cork, decorative papers, high pressure laminates (HPLs), continuous pressure laminates (CPLs), chips of paper, chips of plastic, and combinations thereof.

20. The method according to claim 19, wherein the HPLs and CPLs are decorative semifinished products comprising at least one textile surface structure containing B-stage binders.

21. The method according to claim 1, wherein the laminating comprises discontinuous or continuous pressing or rolling.

22. A method for manufacturing a semifinished product comprising:
a) supplying a carrier;
b) applying a textile surface structure onto at least one surface of the carrier to provide a pre-laminated construction, wherein the textile surface structure has at least one binder present in a B-stage state and wherein the textile surface structure was subjected to a strengthening before it was provided with the at least one binder present in the B-stage state; and
c) laminating the pre-laminated construction under pressure and heat so that the at least one binder present in the B-stage state receives its final hardening.

23. The method according to claim 22, wherein at least one functional material is applied to the textile surface structure after step b).

24. The method according to claim 23, further comprising an additional laminating in order to fix the functional material to the textile surface structure.

25. A composite material comprising:
a) a carrier;
b) at least one textile surface structure applied onto at least one side of the carrier, wherein the textile surface structure comprises at least one finally hardened B-stage binder; and
c) at least one functional material applied on top of the textile surface structure or introduced into the textile surface structure.

26. The composite material according to claim 25, further comprising protective layers applied on the at least one functional material.

27. The composite material according to claim 25, wherein the at least one functional material is selected from the group consisting of flameproofing agents, materials for discharging electrostatic charge, materials for screening off electromagnetic radiation, organic or inorganic pigments, and decorative layers.

28. The composite material according to claim 25, wherein the at least one functional material is present in the form of an independent layer applied in the B-stage binder on a side of the textile surface structure facing away from the carrier or entirely or partially penetrates the textile surface structure.

29. A semifinished product comprising:
a) a carrier; and
b) at least one textile surface structure applied onto at least one surface of the carrier, wherein the textile surface structure has at least one binder present in a B-stage state and an additional strengthening.

30. The semifinished product according to claim 29, wherein the additional strengthening takes place by binders selected from the group consisting of thermoplastic binders, chemical binders, and combinations thereof.

31. The semifinished product according to claim 29, wherein the additional strengthening takes place by physical needling methods, the action of pressure, or physical needling methods and the action of pressure.

32. A decorative semifinished product comprising:
at least one textile surface structure containing at least one B-stage binders; and
at least one decorative layer.

33. The decorative semifinished product according to claim 32, wherein the textile surface structure has an additional strengthening.

34. The decorative semifinished product according to claim 32, further comprising at least one carrier.

35. The decorative semifinished product according to claim 32, comprising between 1 and 25 layers of textile surface structure.

36. The decorative semifinished product according to claim 32, further comprising more than one layer of kraft paper impregnated with a melanine, MUF or phenol B-stage binder.

37. The decorative semifinished product according to claim 32, wherein the at least one decorative layer comprises at least one functional layer.
